(19) United States
(12) Patent Application Publication
(10) Pub. No.: US 2013/0254756 A1
(43) Pub. Date: Sep. 26, 2013

(54) METHOD AND DEVICE TO AUTOMATICALLY UPDATE A COMPUTER SYSTEM

(71) Applicants: Dirk Kroeselberg, Muenchen (DE); Klaus Lukas, Muenchen (DE)

(72) Inventors: Dirk Kroeselberg, Muenchen (DE); Klaus Lukas, Muenchen (DE)

(21) Appl. No.: 13/850,417

(22) Filed: Mar. 26, 2013

(30) Foreign Application Priority Data
Mar. 26, 2012 (DE) 102012204804.9

(51) Int. Cl. G06F 9/445

(52) U.S. Cl. CPC G06F 8/65
USPC 717/171

(57) ABSTRACT

In a method and device to automatically update a computer system, such as a controller for industrial systems, which has multiple components, at least one component of the computer system to be updated is associated with a criticality domain from a number of predetermined criticality domains. A criticality level from a number of predetermined criticality levels is associated to at least one software update provided for one of the components of the computer system. The software updates are automatically transferred to the corresponding components of the computer system according to the criticality domain associated with the component, and according to the criticality levels assigned to the software updates.

### BACKGROUND OF THE INVENTION

1. Field of the Invention

The present invention concerns a method to automatically update a computer system, and a corresponding device.

2. Description of the Prior Art

Regular updates or, respectively, patches for components of computer systems (for example the operating system, and additionally installed software modules or applications) are typical. Such patches add new functions to a component or modify existing functions.

Security-relevant patches are known that reduce the vulnerability of a system to attacks (for example over a network, via malware, via industrial espionage, via viruses and the like), by closing known security holes. For example, this applies to typical industrial and office environments.

As used herein, the term “security” relates to both the operating safety (“safety”) of a computer system and the intrusion security (“security”) of a computer system.

The updating of components in industrial systems or embedded systems is also becoming increasingly relevant. Service operations for such computer systems (for example in industrial PCs, embedded systems or routing centers) can be conducted by exchanging a complete firmware or a complete software image, for example.

In complex environments, however, such as Windows-based systems, regular patches or service packs for individual components of the system are typical. Both new firmware and software images and individual patches or service packs thereby typically include program code which is intended to improve the security with regard to stability and also against external attacks.

The “resilience” of a computer system is also relevant in this context. The “resilience” designates the ability of a computer system to withstand errors and external attacks.

A specific set of components of the computer system is typically critical to the resilience of the computer system (which is composed of different components, for example a controller for industrial systems). These components can be the operating system, drivers, libraries or the like. Other components can be less relevant with regard to the critical functionality of the computer system.

In order to continuously improve the resilience of a computer system, it is typical to patch or to update critical systems, and to thereby ensure a current state of the software in these computer systems. The susceptibility of these computer systems to exploitation of weaknesses is thereby reduced. However, individual components of a system are thereby not typically considered.

This procedure is disclosed in the NERC CIP standard, for example.

In many security-relevant systems (also called “safety-critical” systems), the stability and functionality of the system must also be ensured during and after an update. For example, this can pertain to systems in the field of industrial controllers or control systems for power grids.

### SUMMARY OF THE INVENTION

An object of the present invention is to provide an improved possibility to automatically update computer systems.

This object is achieved in accordance with the invention by a method to automatically update a computer system (in particular a controller for industrial systems) that includes multiple components, the method having the steps of associating at least one component of the computer system to be updated with a criticality domain from a number of predetermined criticality domains, assigning a criticality level from a number of predetermined criticality levels with at least one software update provided for a component of the computer system, and automatically transferring the software updates to the corresponding components of the computer system according to the criticality domain associated with the component, and according to the criticality levels assigned to the software updates.

The above object also is achieved in accordance with the invention by a device for automatic software updating of a computer system, the device having an association device configured to associate at least one component of the computer system to be updated with a criticality domain from a number of predetermined criticality domains, an assignment device configured to assign a criticality level (from a number of predetermined criticality levels) to at least one software update provided for one of the components of the computer system; and an automatic software transfer device configured to transfer the software updates to the corresponding components of the computer system according to the criticality domains associated with the components and according to the criticality levels assigned to the software updates.

The insight forming the basis of the present invention is that different software updates for components of a computer system can affect the functionality of the computer system in different ways.

The present invention takes this insight into account, in order to provide a method in which not only the type of computer system is assessed, but also wherein the individual components of the computer system are classified in different criticality domains. Within the scope of the underlying basis, criticality domains represent a method to assess the criticality of individual systems, components or groups of components. The present invention also assigns a criticality level to the software updates provided for the components of the computer system.

The individual software updates are then automatically transferred to the corresponding components depending on the corresponding criticality domains and the criticality levels.

For example, within a single computer system it is possible to use different procedures for different components given a software update of the respective component.

The method according to the invention therefore enables software updates to individual components of a computer system to be controlled and realized in a very fine-grained manner, and selectively.

In one embodiment, the step of establishing meta-tags and/or criticality indices and/or function descriptions for at least one component of the computer system is provided, wherein the association is implemented based on the meta-tags and/or criticality indices and/or function descriptions for the respective component of the computer system.

If meta-tags and/or criticality indices and/or function descriptions are associated with the components of the computer system, and these are subsequently evaluated automatically in order to associate a respective criticality domain with the corresponding component, components in different computer systems can be used without the association needing to be made manually in each computer system, for example.

For example, a manufacturer of a component of a computer system can already establish the meta-tags and/or criticality indices and/or function descriptions and link these with the component. If such a component is thereupon used in a computer system, this component can very simply be associated with a criticality domain.

In one embodiment, the step of establishing meta-tags and/or criticality indices and/or function descriptions is provided for at least one of the software updates, wherein the assignment is implemented automatically based on the meta-tags and/or criticality indices and/or function descriptions provided for the respective software updates.

If meta-tags and/or criticality indices and/or function descriptions are associated with the software updates and these are subsequently evaluated in order to respectively assign a criticality level to the corresponding software updates, the corresponding criticality levels can very simply be assigned to software updates.

For example, a manufacturer of a software update can already establish the meta-tags and/or criticality indices and/or function descriptions in the production of the software update, and link these with said software update. If such a software update should thereupon be imported to a component of a computer system, this component can very quickly and simply be classified with regard to the criticality level.

The use of meta-tags and/or criticality indices and/or function descriptions to characterize the components of the computer systems and the software updates also has the advantage that the association of the criticality domains and criticality levels can take place automatically.

For example, in one embodiment specific meta-tags can be established that enable an association of a component of the computer system or a software update with a criticality domain or a criticality level.

In a further embodiment, semantic analysis methods can be used in order to analyze the function descriptions of the components of the computer system and the software updates, and to establish a corresponding criticality domain or a corresponding criticality level.

In one embodiment, the steps “determine a dependency of at least one of the components on the additional components of the computer system” and “adapt the association of the at least one component based on the determined dependency of the component on the additional components of the computer system” are provided. This in particular enables hierarchically designed computer systems to be updated securely. For example, it can thus be prevented that a component of a computer system is updated with a fast (but possibly insecure) method that, although it has a very low criticality, is dependent on the very critical components of the computer system. A type of dependency-based update urgency therefore results from the consideration of the dependencies between individual components of the computer system.

In one embodiment, the additional steps “define at least one relevant functionality of the computer system”, “establish the plurality of criticality domains, wherein each criticality domain indicates a different relevance of one of the components of the computer system with regard to the implementation of the relevant functionalities of the computer system”, and “establish the plurality of criticality levels, wherein each criticality level indicates a measure of an influence of at least one of the software updates on the relevant functionalities” are provided. For example, the security of the computer system with regard to external intrusions—for example by attackers, also called “hackers”—can always be viewed as a relevant functionality of the computer system. In a computer system for an industrial system, for example, the correct controller of the industrial system can be in the forefront as an additional relevant functionality of the computer system. This consideration of the relevant functionality can thereby also be implemented for individual sub-regions of a computer system. For example, a single component of a computer system itself can also be considered as a computer system.

The criticality domains can be defined on the basis of different factors. For example, criticality domains can be assessed based on the capabilities to affect the computer system that an attacker achieves via an insecure component. Criticality domains can also be established based on a network architecture of the computer system. For example, a network segment of the computer system can be protected separately via its own firewall. The components of the computer system which are located in this network segment could thereby be associated with a criticality domain that represents a low criticality.

Criticality levels can also be assessed on the basis of multiple factors. Possible factors are, among other things:
How easy is it for attackers to exploit the weakness (probability)?
How much control of the system does an attacker achieve via the weakness?
How significant is the possible economic damage?

The urgency with which the software update should be imported to the affected component, and therefore the criticality level of the software update, result from the evaluation of these factors.

In one embodiment, a first criticality domain indicates a high criticality of a component of the computer system with regard to the implementation of the relevant functionalities. Additionally or alternatively, a second criticality domain indicates a medium criticality of a component of the computer system with regard to the implementation of the relevant functionalities. Additionally or alternatively, a third criticality domain indicates a low criticality of a component of the computer system with regard to the implementation of the relevant functionalities.

In one embodiment, a first criticality level indicates a high measure of the influence of at least one of the software updates on the relevant functionalities. Additionally or alternatively, a second criticality level indicates a medium measure of the influence of at least one of the software updates on the relevant functionalities. Additionally or alternatively, a third criticality level indicates a low measure of the influence of at least one of the software updates on the relevant functionalities.

In one embodiment, the step of the automatic updating has:
delayed updating of at least one of the components of the computer system which is associated with the second criticality domain, and for which a software update of the second criticality level is provided up to a regular revision of the component; and/or
immediate updating of at least one of the components of the computer system which is associated with the third criticality domain, and for which a software update of the first criticality level is provided; and/or
updating of at least one component of a redundant, second computer system and updating of the corresponding components of the computer system which is associated with the first criticality domain and for which a software update of the first criticality level is provided, after an error-free function of the at least one updated component of the redundant second computer system is established.

The cited criticality domains and the criticality levels, in combination with the cited possibilities for updating, enable a very simple and granular automatic control of the software updating of components of a computer system.

Insofar as is reasonable, the above embodiments and developments can be arbitrarily combined with one another. Additional possible embodiments, developments and implementations of the invention also do not explicitly include cited combinations of features of the invention that have previously been described in the following with regard to the exemplary embodiments. In particular, the man skilled in the art will thereby also add individual aspects (as improvements or additions) to the respective basic form of the present invention.

Within the scope of this invention, what is to be understood by the term “computer system is not only a single computer. Rather, a computer system can have a plurality of computers and/or network participants that are networked with one another. The network participants can thereby be (for example) network-capable embedded systems, but also network-capable actuators and sensors.

In one embodiment, the computer system can also be a single computer system or, respectively, a computer program product used in the computer system, and the components of the computer system are individual program modules of the computer program product.

### BRIEF DESCRIPTION OF THE DRAWINGS

FIG. 1 is a flowchart of an embodiment of a method according to the invention.

FIG. 2 is a block diagram of an embodiment of a device according to the invention.

### DESCRIPTION OF THE PREFERRED EMBODIMENTS

In all figures, identical or functionally identical elements and devices have been provided with the same reference characters, insofar as not specified otherwise.

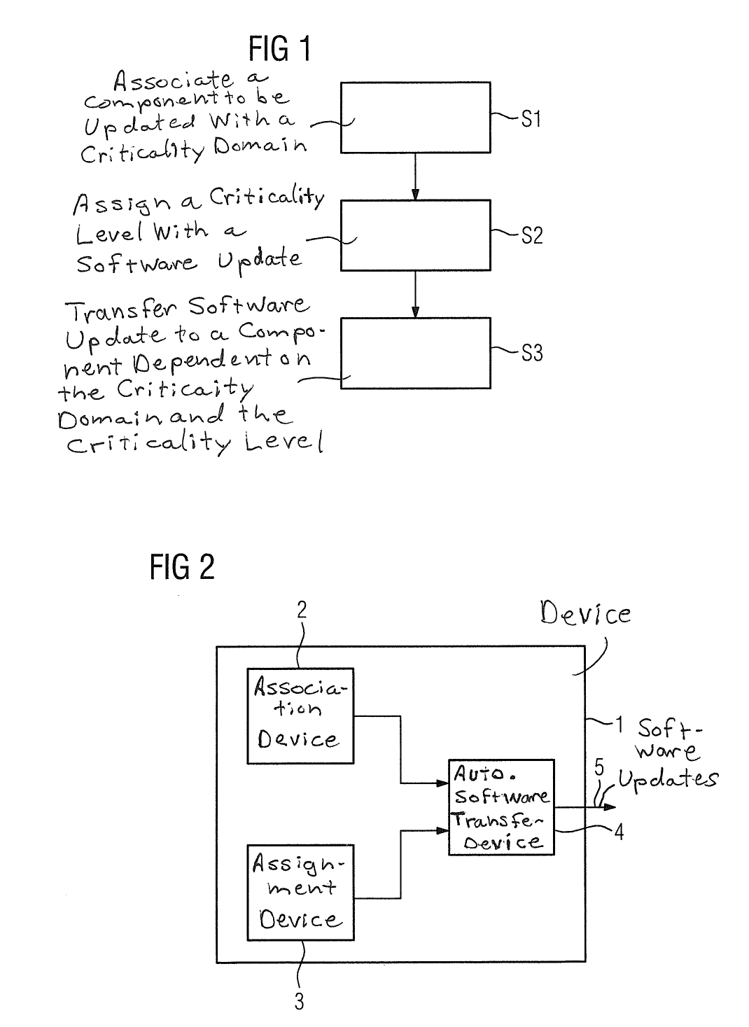

FIG. 1 shows a flowchart of an embodiment of a method according to the invention.

In a first Step S1, at least one component of the computer system to be updated is associated with a criticality domain from a plurality of predetermined criticality domains.

In a second step S2, a criticality level from a plurality of provided criticality levels is assigned to at least one software update 5 provided for one of the components of the computer system.

In a third step S3, the software updates 5 are transferred to the corresponding components of the computer system according to the criticality domain associated with the components, and according to the criticality levels assigned to the software updates 5.

The association S1 of the at least one component of the computer system to be updated thereby automatically occurs using meta-tags, function descriptions and/or criticality indices that (for example) are already established for each of the components in the production of components; in the planning of the computer system which has the respective component; in the installation of the computer system or the like. For example, for this meta-tasks can be provided that identify specific properties or requirements of a component of the computer system, and a predetermined value is associated with each property or requirement. For example, in one embodiment the values of all properties and requirements associated with a component are totaled up, and the respective component is associated with a criticality domain using this sum. For example, a value range can be established for each criticality domain.

Specific meta-tags can also execute a signal function. For example, a component that is labeled with one of these specific meta-tags can immediately be associated with a specific criticality domain, independent of the additional meta-tags which are associated with this component.

In a further embodiment, the association S1 can also be implemented by an administrator.

Finally, individual components of the computer system can be classified in what are known as security zones. A security zone thereby designates a region of the computer system (for example a segment of the data network of a controller of an industrial system) which is protected by specific security measures. For example, components that are highly relevant to the function of the industrial system can be arranged together in a region of the data network of the controller of the industrial system that is protected by a firewall and/or additional protection systems against an unauthorized access.

The assignment S2 of criticality levels with individual software updates 5 can also take place analogous to the association S1 of the components of the computer system with the criticality domains.

In one embodiment, in a further step an analysis is made as to which components of the computer system depends on additional components of the computer system and—if it is necessary—the association of the component with the criticality domains is adapted. Table 1 shows examples of dependencies between components of a computer system.

TABLE 1

| Component | A | B | C |
|---|---|---|---|
| A | X | no | no |
| B | yes | X | yes |
| C | no | yes | X |

Table 1 is designed as a matrix in which the components A, B and C are respectively shown in columns and rows. The fields of the matrix respectively identify the dependency of the component shown in the left column on the corresponding component shown in the first row. The cells that respectively relate to the same component (for example A-A, B-B, C-C) are labeled with an “X”, since a component cannot be dependent on itself.

A “yes” in Table 1 also identifies a dependency of the component shown in the left column on the corresponding component shown in the first row. For example, the component B is dependent on the components A and C.

In one embodiment, the component B is now associated with that criticality domain with which one of the components A and C is associated, and which indicates a higher criticality relative to the relevant functionality of the computer system.

An automatic transfer of the updates to the components can thereupon take place using the components associated with the criticality domains and the criticality levels.

Table 2 shows a possible evaluation matrix using which a selection can be made as to how the respective components of the computer system can be updated. The lower the criticality level in Table 2, the more important the software update 5.

TABLE 2

| | | | | Transfer all SW |
|---|---|---|---|---|
| | | | Derived | updates with |
| | Criticality | | update | criticality |
| Component | domain | Dependency | relevance | level ≧ |
| A | low | low | low | 1 |
| B | low | medium | medium | 3 |
| C | high | high | high | 1 |

For example, in one embodiment the component A can be updated immediately and without an additional test since a malfunction of the component A is non-critical for the computer system.

For example, in one embodiment the component B can be updated with a future, regular system update. Extraordinary testing costs are thereby reduced.

For example, in one embodiment the component C can be very promptly updated since both the component and the software update 5 are critical to the functionality of the computer system. However, the component C is not directly updated. Rather, the software update 5 is imported to a component C of what is known as a staging system or, respectively, a redundant test system. Only if the proper function of the component C with the software update 5 in the staging system is demonstrated is the software thereupon transferred to the component C of the production computer system.

FIG. 2 shows a block diagram of an embodiment of a device according to the invention for automatic software updating 5 of a computer system.

The device 1 has an association device 2 and an assignment device 3 that are both coupled to an automatic software transfer device 4.

The association device 2 is designed to associate at least one component of the computer system to be updated with a criticality domain from a plurality of predetermined criticality domains. The assignment device 3 is also designed to assign a criticality level from a plurality of predetermined criticality levels to at least one software update 5 provided for one of the components of the computer system. Finally, the automatic software transfer device 4 is designed to transfer the software updates 5 to the corresponding components of the computer system according to the criticality domains associated with the components and according to the criticality levels assigned to the software updates 5.

In one embodiment, the association device 2 and the assignment device 3 are designed as processor-controlled devices 2 and 3 that are designed to implement the association and assignment. For this, the association device 2 and the assignment device 3 are designed to implement the association or, respectively, assignment automatically using meta-tags, function descriptions and/or criticality indices that are already established in the production of the components; in the planning of the computer system which has the respective component; in the installation of the computer system or the like for each of the components.

In one embodiment, the device 1 is designed as a computer program product which enables the claimed functionality in a computer (for example a computer operated with the Windows operating system).

In one embodiment, a device is provided to automatically update a computer system, in particular a controller for industrial systems that comprises multiple components, with means to associate S1 at least one component of the computer system to be updated with a criticality domain from a plurality of predetermined criticality domains; means to associate S2 a criticality level from a plurality of predetermined criticality levels with at least one software update 5 provided for one of the components of the computer system; and means to automatically transfer S3 the software updates 5 to the corresponding components of the computer system according to the criticality domain associated to the components and according to the criticality levels assigned to the software updates 5.

In one embodiment, a device according to the invention is provided, with means to establish meta-tags and/or criticality indices and/or function descriptions for at least one of the components of the computer system, wherein the association S1 is implemented automatically based on the meta-tags and/or criticality indices and/or function descriptions that are established for the respective component of the computer system.

In one embodiment, a device according to the invention is provided, with means to establish meta-tags and/or criticality indices and/or function descriptions for at least one of the software updates 5, wherein the assignment S2 is implemented automatically based on the meta-tags and/or criticality indices and/or function descriptions provided for the respective software updates 5.

In one embodiment, a device according to the invention is provided, with means to determine a dependency of at least one of the components of the computer system on the additional components of the computer system; and means to adapt the association of the at least one component with at least one of the predetermined criticality domains, based on the determined dependency of the component on the additional components of the computer system.

In one embodiment, a device according to the invention is provided, with means to define at least one relevant functionality of the computer system; means to establish the plurality of criticality domains, wherein each criticality domain indicates a different relevance of one of the components of the computer system with regard to the implementation of the relevant functionalities of the computer system; and means to establish the plurality of criticality levels, wherein each criticality level indicates a measure of an influence of at least one of the software updates 5 on the relevant functionalities.

In one embodiment, a device according to the invention is provided, wherein a first criticality domain indicates a high criticality of a component of the computer system with regard to the implementation of the relevant functionalities of the computer system; and/or wherein a second criticality domain indicates a medium criticality of a component of the computer system with regard to the implementation of the relevant functionalities of the computer system; and/or wherein a third criticality domain indicates a low criticality of a component of the computer system with regard to the implementation of the relevant functionalities of the computer system; and/or wherein a first criticality level indicates a high measure of influence of at least one of the software updates 5 on the relevant functionalities; and/or wherein a second criticality level indicates a medium measure of influence of at least one of the software updates 5 on the relevant functionalities; and/or wherein a third criticality level indicates a high measure of influence of at least one of the software updates 5 on the relevant functionalities.

In one embodiment, a device according to the invention is provided, wherein the means for automatic updating S3 have means for delayed updating of at least one of the components of the computer system which is associated with the second criticality domain, and for which a software update 5 of the second criticality level is provided, up to a regular revision of the component; and/or immediate updating of at least one of the components of the computer system which is associated with the third criticality domain, and for which a software update 5 of the first criticality level is provided; and/or updating of at least one component of a redundant second computer system, and updating of the corresponding components of the computer system which is associated with the first criticality domain, and for which a software update 5 of the first criticality level is provided, after an error-free function of the at least one updated component of the redundant second computer system is established.

Although modifications and changes may be suggested by those skilled in the art, it is the intention of the inventors to embody within the patent warranted hereon all changes and modifications as reasonably and properly come within the scope of their contribution to the art.

I claim as my invention:

1. A method to automatically update a computer system that comprises multiple components, said method comprising the steps:
associating at least one component of the computer system to be updated with a criticality domain from a plurality of predetermined criticality domains;
assigning a criticality level from a plurality of predetermined criticality levels with at least one software update provided for one of the components of the computer system; and
automatically transferring the software updates to corresponding components of the computer system according to the criticality domain associated with the component, and according to the criticality levels assigned to the software updates.

2. A method as claimed in claim 1, comprising:
establishing meta-tags and/or criticality indices and/or function descriptions for at least one component of the computer system; and
implementing the association based on the meta-tags and/or criticality indices and/or function descriptions that are established for the respective component of the computer system.

3. A method as claimed in claim 1, comprising:
establishing meta-tags and/or criticality indices and/or function descriptions for at least one of the software updates;
implementing the assignment automatically based on the meta-tags and/or criticality indices and/or function descriptions provided for the respective software updates.

4. A method as claimed in claim 1, comprising:
determining a dependency of at least one of the components of the computer system on the additional components of the computer system; and
adapting the association of the at least one component with at least one of the predetermined criticality domains based on the defined dependency of the component on the additional components of the computer system.

5. A method as claimed in claim 1, comprising:
defining at least one relevant functionality of the computer system;
establishing a plurality of criticality domains so each criticality domain indicates a different relevance of one of the components of the computer system with regard to the implementation of the relevant functionalities of the computer system; and
establishing the plurality of criticality levels so each criticality level indicates a measure of an influence of at least one of the software updates on the relevant functionalities.

6. A method as claimed in claim 5, comprising establishing said plurality of criticality domains, by establishing one or more of:
a first criticality domain that indicates a high criticality of a component of the computer system with regard to the implementation of the relevant functionalities;
a second criticality domain that indicates a medium criticality of a component of the computer system with regard to the implementation of the relevant functionalities;
a third criticality domain that indicates a low criticality of a component of the computer system with regard to the implementation of the relevant functionalities;
and comprising assigning one or more of:
a first criticality level that indicates a high measure of the influence of at least one of the software updates on the relevant functionalities;
a second criticality level that indicates a medium measure of the influence of at least one of the software updates on the relevant functionalities; and
wherein a third criticality level indicates a low measure of the influence of at least one of the software updates on the relevant functionalities.

7. A method as claimed in claim 6, comprising establishing said plurality of criticality domains, by establishing one or more of:
delayed updating of at least one of the components of the computer system which is associated with the second criticality domain, and for which a software update of the second criticality level is provided up to a regular revision of the component;
immediate updating of at least one of the components of the computer system which is associated with the third criticality domain, and for which a software update of the first criticality level is provided; and
updating of at least one component of a redundant, second computer system and updating of the corresponding components of the computer system which is associated with the first criticality domain and for which a software update of the first criticality level is provided, after an error-free function of the at least one updated component of the redundant second computer system is established.

8. A device for automatic software updating of a computer system, comprising:
an association device configured to associate at least one component of the computer system to be updated with a criticality domain from a plurality of predetermined criticality domains;
an assignment device configured to assign a criticality level from a plurality of predetermined criticality levels to at least one software update provided for one of the components of the computer system; and
an automatic software transfer device configured to transfer the software updates to corresponding components of the computer system according to the criticality domains associated with the components and according to the criticality levels assigned to the software updates.

9. A device as claimed in claim 8, comprising:
a first specification device configured to automatically read out from a data source meta-tags and/or criticality indices and/or function descriptions for at least one of the components of the computer system, and/or to receive these from a user; and
the association device is configured to automatically associate with the corresponding components a criticality domain from the plurality of criticality domains, based on the meta-tags and/or criticality indices and/or function descriptions received for the respective component.

10. A device as claimed in claim 9, comprising:
a second specification device which is configured automatically read out from a data source meta-tags and/or criticality indices and/or function descriptions for one of the software updates, and/or to receive these from a user; and
wherein the assignment device is configured to automatically assign to the corresponding software updates a criticality level from the plurality of criticality levels, based on the meta-tags and/or criticality indices and/or function descriptions received for the respective software update.

11. A device as claimed in claim 10, wherein the association device is also configured to determine a dependency of at least one of the components of the computer system on the additional components of said computer system, and to adapt the association of the at least one component with at least one predetermined criticality domain based on the defined dependency of the component on additional components of the computer system.

12. A device as claimed in claim 11, comprising:
a third specification device configured to read a relevant functionality of the computer from a data source and/or receive this from a user, and to predetermine at least one of the criticality domains and/or one of the criticality levels;
wherein each of the predetermined criticality domains indicates a different relevance of one of the components of the computer system with regard to the security and relevant functionality of said computer system; and
wherein each of the predetermined criticality levels indicates a measure of an influence of at least one of the software updates on the relevant functionalities.

13. A device as claimed in claim 12, wherein the third specification device is configured to predetermine one or more of:
a first criticality domain which indicates a high criticality of a component of the computer system with regard to the implementation of the relevant functionalities of said computer system;
a second criticality domain which indicates a medium criticality of a component of the computer system with regard to the implementation of the relevant functionalities of said computer system;
a third criticality domain which indicates a low criticality of a component of the computer system with regard to the implementation of the relevant functionalities of said computer system;
a first criticality level which indicates a high measure of the influence of at least one of the software updates on the relevant functionalities;
a second criticality level which indicates a medium measure of the influence of at least one of the software updates on the relevant functionalities; and/or
a third criticality level which indicates a low measure of the influence of at least one of the software updates on the relevant functionalities.

14. A device as claimed in claim 13, wherein the automatic software transfer device is configured to:
update with a delay at least one of the components of the computer system which is associated with the second criticality domain, and for which a software update of the second criticality level is provided, with a regular revision of the component;
immediately update at least one of the components of the computer system which is associated with the third criticality domain, and for which a software update of the first criticality level is provided; and
update a component of a redundant second computer system and the corresponding components of the computer system with which the first criticality domain is associated and for which a software update of the first criticality level is provided, after an error-free function of the at least one updated component of the redundant second computer system is established.
